(19) United States
(12) Patent Application Publication
(10) Pub. No.: US 2018/0316997 A1
(43) Pub. Date: Nov. 1, 2018

(54) MUSICAL ASSEMBLY FOR USE WITH ONE OR MORE BALLOONS FOR PLAYING AUDIO SOUNDS

(71) Applicant: Jack Benun, Dunellen, NJ (US)

(72) Inventor: JACK BENUN, Dunellen, NY (US)

(21) Appl. No.: 15/581,493

(22) Filed: Apr. 28, 2017

(51) Int. Cl. H04R 1/02; G06F 3/16; A63H 27/10; A63H 33/26; A63H 5/00

(52) U.S. Cl. CPC H04R 1/028; G06F 3/165; A63H 27/10; A63H 2027/1058; A63H 5/00; H04R 2420/07; A63H 33/26

(57) ABSTRACT

The present invention provides for a musical assembly used with one or more inflatable balloons, comprising one or more audio players for receiving and transmitting audio signals, and one or more extendable wire cables each having a proximal end that is extendably and electronically connected to the audio player; and a distal end that is electronically connected to one or more speaker modules. Each of the speaker modules includes a housing having at least one speaker therein for playing sounds and has an adapter therein for releasably connecting each of the speaker modules to an inflatable balloon. Each of the inflatable balloons comprises a gas expandable interior and an outer surface, wherein the sounds are amplified when they pass through the gas expandable interior and cause the outer surface of each of the inflatable balloons to vibrate. This further amplifies the sound from each of the inflatable balloons.

### FIELD OF THE INVENTION

The present invention relates to a musical assembly that is used with one or more balloons for receiving and playing sounds that are amplified by each of the balloons.

### BACKGROUND OF THE INVENTION

Inflatable balloons filled with helium or other gas are often used at parties, gatherings, celebrations and a variety of entertainment events. Typically, balloons are used for decoration of the event space and can have a variety of shapes and sizes. Inflatable balloons that include a music-producing device either within the interior of the balloon or attached to the exterior of the balloon are known in the art. The music-producing devices used with balloons are simple electrical assemblies, which typically include a chip storing thereon one or more musical melodies thereon, a battery for powering the chip and a speaker connected to the chip for producing tones in accordance with the melodies stored on the chip.

### DESCRIPTION OF THE PRIOR ART

Prior art U.S. Pat. No. 5,108,338 discloses an example of such a music-producing device which is adhered to the balloon using a patch of material with an adhesive. Also prior art U.S. Pat. No. 7,674,152 discloses another music-producing device which is used with a balloon weight system. The balloon weight system of the '152 patent includes a chip storing music thereon provided on a balloon weight, and an acoustic medium located remotely from the balloon weight and attached to a balloon, so that the acoustic medium vibrates the balloon wall in response to a signal generated by the chip. Similarly, prior art U.S. Pat. No. 7,551,061 discloses a balloon for producing polyphonic sounds in response to sound signals generated by a chip. Furthermore, prior art US Patent Publication No. 2011/0218811 discloses an oscillator unit directly attached to a surface of the balloon body.

These conventional music producing devices store music to be played on the device. Therefore, the music that can be played using the balloon as an amplifier is limited to the music stored on the chip included with the device. Moreover, due to the use of adhesives to attach the device and/or the acoustic element to the balloon's surface, multiple uses of these devices may not be possible or may be limited. Furthermore, the sound produced with these prior art devices is not a clear or vibrant because piezoelectric buzzers or oscillators, instead of speakers, are directly attached to the surface of the balloons.

### OBJECTS OF THE INVENTION

It is an object of the present invention is to provide a musical assembly that can be used with one or more inflatable balloons, in which one or more speaker modules is each attached to the surface of one or more inflatable balloons such that the balloon amplifies the sounds from one or more speakers.

It is another object of the present invention to provide a musical assembly that can be used with one or more inflatable balloons, having one or more audio players which each can wirelessly receive sound signals from one or more external audio devices through a Bluetooth connection between one or more audio players and one or more external audio devices.

It is another object of the present invention to provide a musical assembly that can be used with one or more inflatable balloons, having one or more audio players which each can wirelessly receive sound signals from one or more external audio devices through a wired connection between one or more audio players and one or more external audio devices.

It is another object of the present invention to provide a musical assembly that can be used with one or more inflatable balloons, having one or more audio players which can each be wirelessly controlled via a Bluetooth connection between one or more audio players and one or more external control panel.

It is another object of the present invention to provide a musical assembly that can be used with one or more inflatable balloons, having one or more audio players which can be controlled by an integral control panel or a control panel connected to one or more of the audio players each via a wired connection.

It is another object of the present invention to provide a musical assembly that can be used with one or more inflatable balloons, having one or more audio players having one or more detachably attached speaker modules.

It is another object of the present invention to provide a musical assembly that can be used with one or more inflatable balloons, that can be used as a speaker phone, a loud speaker, or as a karaoke device.

### SUMMARY OF THE INVENTION

The present invention provides a more versatile music producing device which can be used with multiple balloons and can play a variety of music. The present invention also provides additional advantages, which but are not limited to, the ability to wirelessly transmit musical or other sounds to the music producing device from an external device, the ability to easily attach and detach a speaker to and from the balloon via an adapter, the ability receive sounds via a microphone either built into the music producing device or wirelessly connected to the music producing device, and the ability connect the music producing device to multiple balloons so as to play sounds corresponding to the same signal via multiple speakers.

### BRIEF DESCRIPTION OF THE DRAWINGS

The above and other features and aspects of the present invention will become more apparent upon reading the following detailed description in conjunction with the accompanying drawings, in which:

FIG. 1 shows an overall musical assembly of the invention used with a balloon;

FIG. 2 shows an illustrative configuration of the musical assembly of FIG. 1;

FIGS. 3A-3C show another illustrative configuration of the musical assembly of FIG. 1;

FIGS. 4A-4B show a balloon adapter for attaching a balloon to the musical assembly of FIG. 1;

FIGS. 5A-5C show attachment of a speaker module of the musical assembly of FIG. 1 to the balloon adapter of FIGS. 4A-4B;

FIG. 6 shows a detailed view of the musical assembly of FIG. 1 and its internal components;

FIGS. 7A-7C show a detailed view of the speaker module of the musical assembly of FIG. 1 and its internal components;

FIG. 8 shows another view of the musical assembly of FIGS. 3A-3C; and

FIGS. 9A-9E show perspective, front, top, bottom and side views of the musical assembly of FIGS. 3A-3C with illustrative dimensions thereof.

FIGS. 10A and 10B show another configuration of the musical assembly of the present invention.

FIG. 11 shows a detailed view of another configuration of the musical assembly of the present invention.

### DETAILED DESCRIPTION OF THE PREFERRED EMBODIMENT

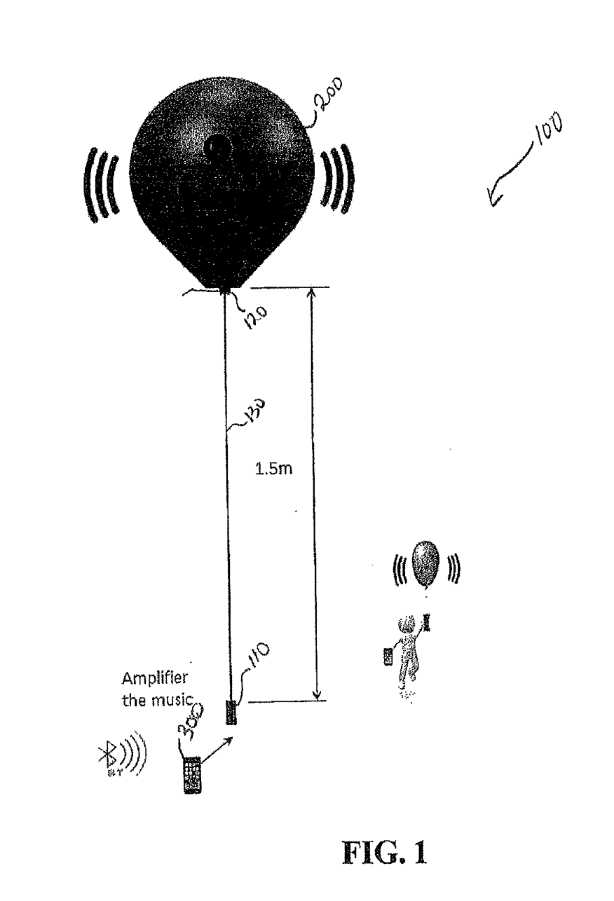

FIG. 1 shows an overall musical assembly 100 used with an inflatable balloon 200 and an external device 300, wherein the musical assembly 100 receives a music or sound signal from the external device 300 via a wireless or a wired connection and plays the music or sound using the balloon as an amplifier/resonator. In FIG. 1, the external device 300 is shown as a smartphone or a mobile phone. However, other portable and non-portable devices may be used as the external device 300, including, but not limited to, a portable music player, a radio tuner, a mobile or remote terminal (cellular or landline telephone), a CD/DVD player, a Radio Data System (RDS) tuner, an Internet radio, a cassette player, a satellite radio, a text-to-speech system, a television tuner, an MP3 player, a computer, an audio/visual system, a navigation system, or other devices capable of storing and/or producing music or other sounds.

In addition, the musical assembly in FIG. 1 and described below is used with an inflatable balloon and uses the air or gas, such as helium gas, in the balloon as a media for transmitting sounds. However, it is contemplated that the present invention can also be used with other devices capable of transmitting the sound, such as an airship, a bottle, a box, etc.

As shown in FIG. 1, the musical assembly 100 includes a music player 110, which can receive a sound signal from the external device 300 and also includes a microphone (not shown in FIG. 1) for receiving sounds from outside of the musical assembly 100. In the configuration of FIG. 1, the music player 110 receives sound signals from the external device 300 wirelessly, such as through a Bluetooth connection between the music player and the external device. However, in other embodiments, a wired connection between the music player 110 and the external device may be provided, as an option in addition to wireless connectivity. The illustrative wired connection may be a direct plug, such as a 3.5 mm jack, into the external device which is connected to the music player 110 by a wire, which may be extendable/retractable.

As shown, the musical assembly 100 also includes a speaker module 120 which is releasably connected to the balloon using an adapter and which is also connected to the music player 110 via a cable 130. The cable 130 can comprise a speaker wire of a predetermined length, such as 1.5 meters, and can be wound and stored away inside the music player 110, as discussed below and shown in other figures.

As discussed in more detail below, the speaker module 120 includes a housing which is configured to releasably connect to the adapter connected with a balloon and a speaker for playing sounds. The speaker can be a resonance speaker, a vibration speaker or any other suitable speaker that, when playing sounds, transforms a balloon surface into a speaker so as to play clear, loud, rich and full sound. As shown in FIG. 1, the musical assembly 100 can play sounds at a level of around 80 dB or greater from about 1.5 meters away from the balloon in an indoor location. The sound levels will depend on the type of speaker used in the speaker assembly and the size of the balloon.

The musical assembly 100 of FIG. 1 can be used with any types of inflatable balloons. In the illustrative configuration of FIG. 1, the balloon is a spheroid aluminum foil balloon which has a diameter of about 70 cm and a volume of about 80 L and which is inflated with helium gas. Other sizes of balloons, which are smaller or larger than the balloon of FIG. 1 may be used. Moreover, other gases may be used to inflate the balloons.

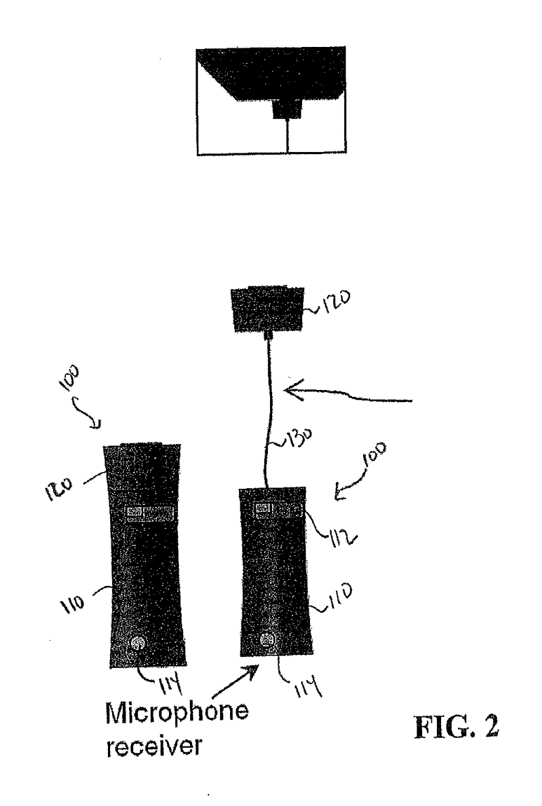

FIG. 2 shows a larger view of the musical assembly of FIG. 1 which has a first configuration. As shown, the musical assembly 100 in FIG. 2 has a substantially cylindrical configuration and when the musical assembly is not being used to play music using a balloon, the music player 110 and the speaker module 120 are positioned adjacent to one another so as to form the cylindrical assembly, with the cable 130 being stored away within the music player 110. When the musical assembly 100 is used with a balloon, the speaker module 120 may be separated from the music player 110, extended so as to unwind the cable 130 stored in the music player and connected to the balloon via the adapter. A winding mechanism may be used within the music player 110 to wind and unwind the cable 130 so as to hide the cable 130 or a portion thereof within the music player 110 when wound and to the cable 130 or a portion thereof when unwound. One or more locking devices may be provided within the winding mechanism so as to lock the position of the cable 130 relative to the winding mechanism and to control the amount of the cable 130 extending from the music player 110. Although FIG. 2 shows an illustrative configuration of the musical assembly having a cylindrical configuration, it is understood that the configuration is not limited to this particular shape. For example, a spherical or an oblong configuration may be used wherein a portion of the spherical or oblong housing includes the music player and another portion includes the speaker module which can be separated from the music player. Other shapes of the musical assembly may also be used.

The musical assembly 100 is constructed so that the weight of the music player 110 is sufficient to serve as a weight for the balloon to prevent the balloon from flying away. The weight of the speaker module 120, however is sufficiently low so as not to affect the balloon's ability to stay up in the air. Lightweight materials may be used for forming the housing of the speaker module and the adapter, and small and lightweight speaker may be used in the speaker module.

As can be seen in FIG. 2, the music player 110 includes a switch 112 for turning the music player ON and OFF. The position of the switch may be varied. Moreover, the music player includes a microphone receiver 114 disposed in its sidewall. The position of the microphone receiver 114 may be varied.

As shown, the speaker module 120 can be releasably coupled to an adapter on a balloon so as to connect the speaker in the speaker module to the balloon. As described in more detail below, the housing of the speaker module 120 includes a groove adapted to receive a cam on the adapter and for locking the cam within the groove. When the adapter is rotated relative to the speaker module, the cam of the adapter moves within the groove so as to lock the cam within the groove, and to thus couple the adapter and the balloon to the speaker module 120.

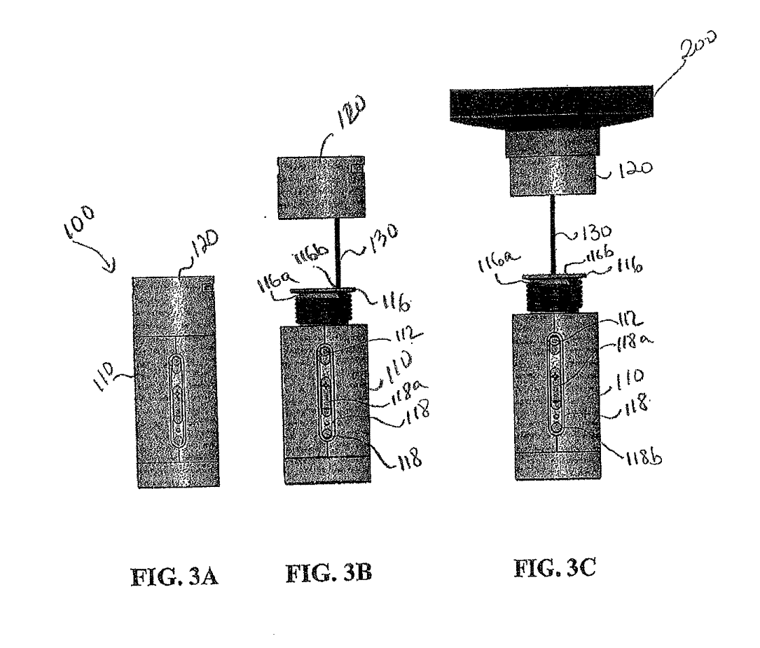

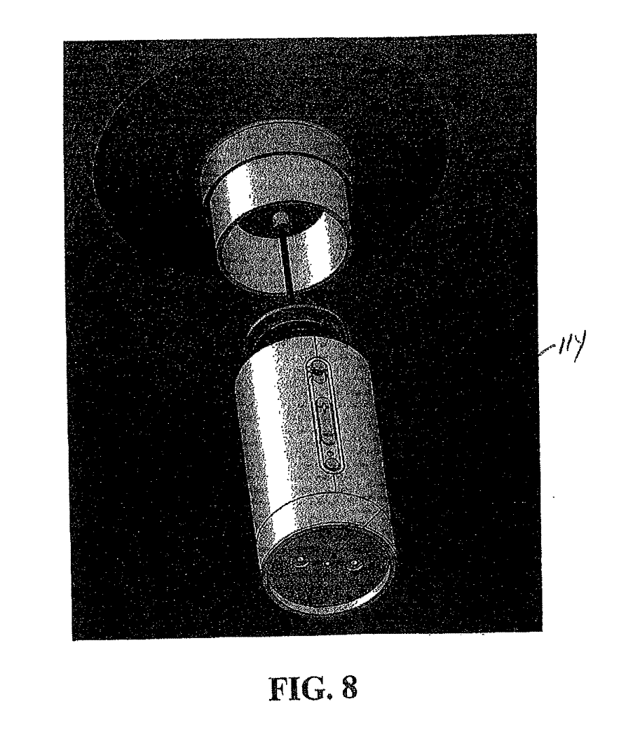

FIGS. 3A-3C show another configuration of the musical assembly of FIG. 1. FIG. 8 shows the musical assembly 100 of FIGS. 3A-3C viewed from the bottom. The musical assembly 100 has a cylindrical configuration when it is in a closed or unused state. Like the configuration of FIG. 2, the musical assembly 100 of FIGS. 3A-3C includes the music player 110, the speaker module 120 and the cable 130 connecting the music player 110 to the speaker module 120 and extendable from the music player 110. FIG. 3A shows the musical assembly 100 in a closed/unused state, FIG. 3B shows the musical assembly 100 in a state with the cable 130 partially extended, and FIG. 3C shows the musical assembly 100 in a state with the cable 130 partially extended and the speaker module 120 attached to an adapter with a balloon 200.

In the configuration of FIGS. 3A-3C, the music player 110 includes a cable spool 116 extending from a top surface of the music player 110 and used for winding the cable 130 onto a reel 116a for storage. The cable spool 116 is dimensioned so as to fit within the housing of the speaker module 120 when the speaker module 120 is positioned on top of the music player 110 so as to hide the cable 130. The cable spool 116 includes an opening 116b in its top surface through which the cable extends. The cable spool 116 preferably has a rotating reel which rotates when the cable is wound and unwound. Moreover, the cable spool 116 can be a spring-loaded spool mechanism that allows the cable to be extended and locked with respect to the spool 116 at any position, and to be released so as to wind the cable 130 into the spool.

The music player 110 of FIGS. 2-10B includes a control panel 118 which includes an ON-OFF switch 112, a volume control 118a, and one or more other controls 118b, which can be used for stopping, pausing or playing music, for advancing to a next track, rewinding to a previously played track or to the beginning of the track, for turning ON-OFF a microphone, etc. The control panel may also include one or more LED indicator lights which are used to show an ON-OFF state of the music player 110, a charge state of the battery, a stop or play state of the music player 110 and/or other states. In the configuration of FIGS. 3A-3C, the control panel is provided in the sidewall of the cylindrical housing of the music player 110. In the configuration of FIG. 2, the control panel is provided in the bottom wall of the housing of the music player 110. The location of the control panel is not limited to these locations and may be provided anywhere in the music player depending on the desired configuration. It is understood that in some embodiments, the music player 110 may not have a control panel at all or may include a limited control panel with only some of the control functions wherein other controls are performed via an external device and are transmitted from the external device to the music player 110 wirelessly or through a wire. The music player 110 also includes a microphone 114 which can be provided in the bottom surface of the music player 110, as shown in FIG. 8.

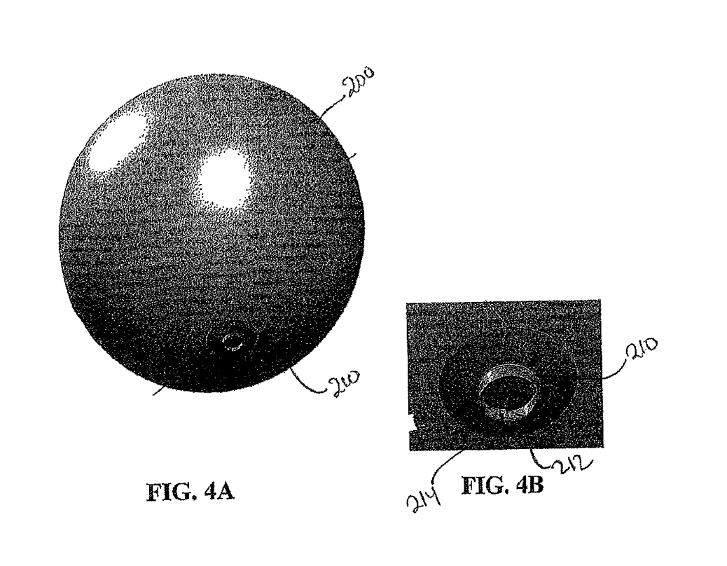

FIGS. 4A and 4B show a balloon 200 with an adapter 210 that can be used for attaching the balloon 200 to the musical assembly of FIG. 1. The adapter 210 may be pre-attached to the balloon surface or may be provided separately from the balloon and may be attached to the balloon by adhesive bonding or the like. The adapter 210 comprises a substantially cylindrical barrel 212 with one end of the barrel being attached to the balloon 200. An inner surface of the barrel includes a cam 214 adapted to be inserted into a groove provided on the housing of the speaker module 120 of the musical assembly. The adapter may be made from any suitable rigid material, which are preferably also light-weight, such as plastics or metallic materials.

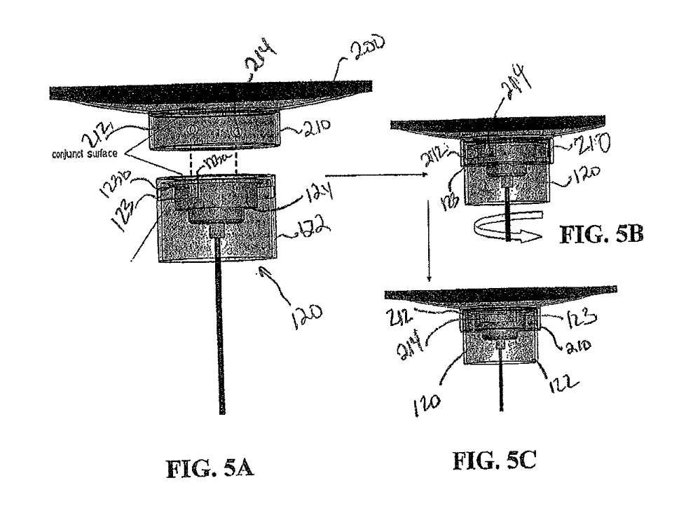

FIGS. 5A-5C show the coupling between the speaker module 120 and the adapter 210 attached to a balloon 200. As shown, the speaker module 120 includes an outer housing 122 which is formed as a cylindrical barrel, and a speaker 124 housed within the housing and connected to an end of the cable 130. The speaker 124 is positioned so that a face of the speaker is exposed from a top opening of the cylindrical outer housing 122. In this way, when the speaker module 120 is coupled with the adapter 210, the speaker 124 is positioned adjacent the balloon's surface. The outer housing 122 is sized to have a smaller diameter than the diameter of the adapter 210 so that the outer housing 122 can be inserted into the adapter 210 and so that an outer wall of the outer housing 122 is adjacent the inner wall of the adapter 210.

As discussed above, the adapter 210 is formed as a cylindrical barrel 212 which includes a cam 214 on its inner surface. The outer housing 122 of the speaker module 210 includes an L-shaped groove 123 in its outer wall, including a first groove portion 123a extending from an upper end of the housing wall followed by a second groove portion 123b extending substantially perpendicular to the first groove portion 123a. As shown in FIG. 5A, to couple the speaker module 120 with the adapter 210 the cam 214 is inserted into the first groove portion 123a, and as further shown in FIGS. SB and SC, the speaker module 120 and the adapter 210 are rotated with respect to each other so that the cam 214 is inserted into the second groove portion 123b and moved to an opposing end of the second groove portion 123b. A locking portion may be provided near the opposing end of the second groove portion 123b so as to releasably lock the cam 214 within the groove 123. The locking portion may be in the form of a small protrusion near the opposing end of the second groove portion 123b.

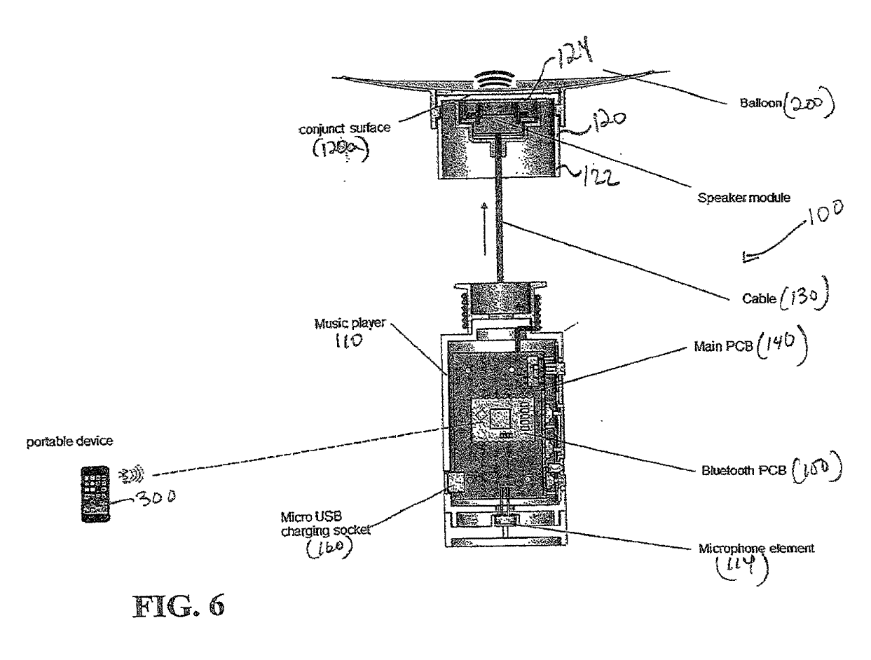

FIG. 6 shows a more detailed construction of the musical assembly 100 of FIG. 1, and in particular of the musical assembly 100 of FIGS. 3A-3C. It is understood that the musical assembly of FIG. 2 would include same or similar components to those shown in FIG. 6, and the configuration of the music player would be modified to include an internal spooling mechanism for the cable 130.

The music player 110 includes a processor assembly, such as a built in printed circuit board assembly (PCBA). As shown in FIG. 6, the music player 110 includes a main processor 140, or main printed circuit board (PCB) for controlling the overall operation of the music player 110, including but not limited to controls relating to connecting to and communicating with one or more external devices 300, receiving audio signals and/or from an external device 300, controlling the operation of a microphone 114, receiving audio signals from the microphone, receiving input signals from the control panel 118, controlling the operation of the speaker module 120 and power management control of the musical assembly 100. The music player 110 may also include a separate communication processor 1 SO, such as a Bluetooth processor, for controlling wireless communication of the music player 110 with one or more external devices 300, such as using Bluetooth or other wireless communication protocol. The communication processor 150 may control the pairing operation between the music player 110 and the external device 300 as well as the subsequent communication of signals between the music player and the external device. In addition, the communication processor 150 may control receiving the signals, including audio signals, from the external device(s) 300 via wireless communication, e.g., Bluetooth.

The music player 110 further includes a battery (not shown) and a charging port 160 or socket, which can be a USB charging port, a micro USB charging port, a proprietary charging port, or any other suitable charging port, to enable charging of the battery of the music player 110.

As shown in FIG. 6 and described above, the speaker module 120 includes a housing 122 which houses therein a speaker 124 and which is adapted to couple with an adapter on the balloon 200 as discussed above. The speaker 124 is connected to the music player 110 by the cable 130, which can be a retractable cable for adjusting its length as described above. The speaker 124 receives signals via the cable 130 for playing audio sounds from the main processor 140 of the music player 110. The speaker 124 is positioned within the housing 122 so that when the speaker module 120 is coupled with the adapter on the balloon, the speaker 124 is disposed adjacent to or abutting the balloon's surface. The surface where the balloon's surface abuts the speaker 124 is referred to as the conjunct surface 120a. When the speaker 124 receives audio signals and outputs sounds, the speaker 124 generates a fluctuation of air pressure caused by vibration through the conjunct surface and thus, the gas in the balloon acts as an amplifier for the sounds output from the speaker 124.

The musical assembly 100 of FIG. 6 operates as follows, when the musical assembly is coupled with a balloon. The music player 110 is first paired with the external device 300 under the control of the communication processor 150 and/or the main processor 140 so as to establish wireless communication between the music player 110 and the external device 300. When the music player and the external device are connected by a wired connection, pairing is usually unnecessary. After the music player 110 and the external device 300 are connected, the music player 110 receives audio signals generated by the portable device 300 via the communication processor 150 or via the main processor 140 and/or receives audio signals input from the microphone 114 via the main processor 140. In some embodiments, the main processor 140 converts digital audio signals received from the external device 300 and/or from the microphone 114 into analog signals and controls to amplify and transmit the analog signals to the speaker 124 via the cable 130. In other embodiments, the main processor 140 receives digital audio signals from the external device 300 and/or from the microphone 114 and transmits the digital audio signals to the speaker 124 without converting these signals to analog signals. The speaker 124 outputs the sounds corresponding to the audio signals received from the music player 110, causing a vibration against the conjunct surface so that the sounds are further amplified by the gas in the balloon.

In some embodiments, the main processor 140 simultaneously receives audio signals from both the external device 300 and the microphone 114, and in such embodiments, the main processor 140 processes the received signals so as to combine them and to transmit a combined audio signal to the speaker 124, which then outputs the combined signal as sound. By allowing the audio signals from the external device 300 and from the microphone 114 to be output simultaneously, the musical assembly 100 of the present invention can be used as a Karaoke device so that users can sign along via the microphone when the music from the external device is being played.

When processing the received signals to generate the combined audio signal, the main processor 140 may control the amplitude of each of the audio signals based priority of each input. For example, if the audio input from the microphone 114 has a higher priority than the audio input from the external device 300, the main processor 140 would control the amplitude of the audio signal from the microphone 114 to be higher while controlling the amplitude of the audio signal from the external device 300 to be lower. This processing by the main processor 140 allows the sounds corresponding to the higher priority audio signal to be heard more clearly while the sound level of the lower priority audio signal is reduced. Therefore, if music transmitted from the external device is being played by the musical assembly 100 and then an announcement is made using the microphone 114 on the music player, the music transmitted from the external device can continue to be played at a reduced level during the announcement, without interruption, so that the announcement is heard at a higher level.

In some embodiments, the main processor 140 may control the audio signal transmission to the speaker so as to transmit only the audio signal corresponding to either the audio signal received from the external device 300 or from the microphone 114. This control by the main processor 140 may also be based on the priority of each input. Thus, if the audio signal from the microphone has a higher priority than the priority of the audio signal from the external device, then in a case when the main processor 140 receives both the audio signal from the external device 300 and the audio signal from the microphone 114, the main processor 140 controls to transmit only the audio signal corresponding to the microphone audio signal to be played by the speaker. Therefore, if music transmitted from the external device 300 is being played by the musical assembly 100 and then an announcement is made using the microphone on the music player 110, the main processor 140 controls to stop playing the music transmitted from the external device and transmits only the audio signal from the microphone 114 to the speaker 124.

The above described input priorities may be pre-set in the music player, or may be set and changed using the control panel 118 or using an external device, including using the portable external device 300. Moreover, one of the settings of the music player 110 may include turning ON and OFF the above-described processing by the main processor 140 so as to generate a combined audio signal and to transmit the combined audio signal to the speaker. This setting would allow the user to indicate whether or not they would like to have two or more audio signals to be combined and output together by the speaker 124 or whether they would like to have only one audio signal to be output by the speaker 124 when two or more audio signals are received by the music player 110. In other embodiments, the audio signals do not have priorities and both the audio signal received from the external device and the audio signal received from the microphone are output to the speaker at the same time at their respective amplitudes. In any case, the microphone 114 in the music player 110 allows the musical assembly to be used as a speaker phone, a loud speaker, a karaoke device, and many other applications.

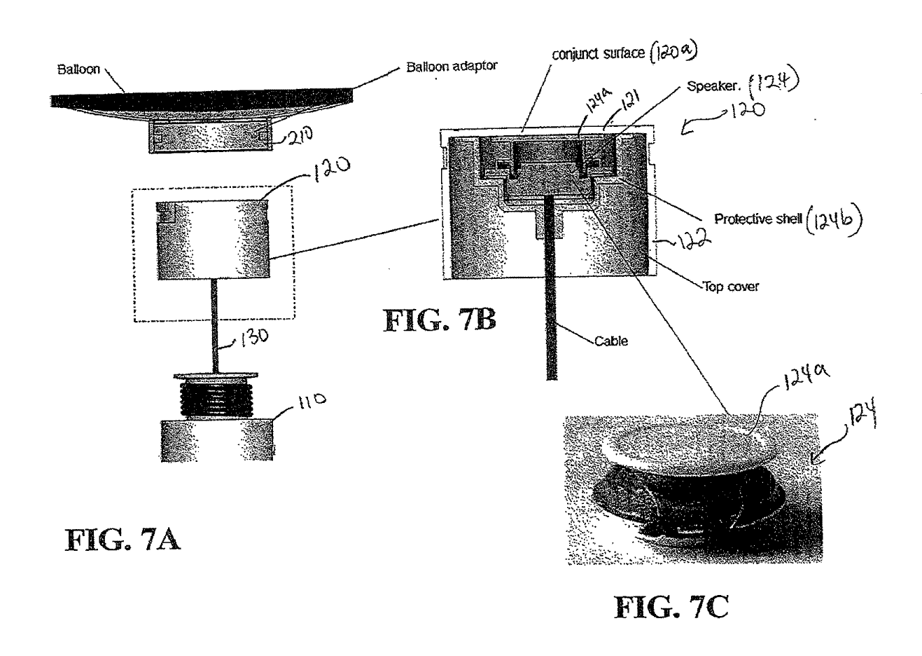

FIGS. 7A-7C show in more detail the configuration of the speaker module 120 and of the speaker 124 included in the speaker module 120. In FIG. 7A, the speaker module 120 is shown with the balloon adapter 210 and the cable 130 connected to the top portion of the music player 110. FIG. 7B shows a cross-section of the speaker module 120 of FIG. 7A and FIG. 7C is a photograph of the speaker 124 included in the speaker module 120 in FIGS. 7 A-7B. As shown in FIG. 7B, the speaker module 120 includes the housing 122 that houses the speaker 124 and which is adapted to couple with the adapter 210 on the balloon as described above. The housing 122 has a substantially cylindrical shape and may include a flange at the top of the cylinder for attaching to the speaker 124. In some embodiments, the top of the cylinder may be formed as a dust cap 121 for the speaker 124 so that when the speaker module is attached to the balloon, the dust cap 121 forms the conjunct surface 120a abutting the balloon's surface.

As shown in FIGS. 7B and 7C, the speaker 124, which is preferably a vibration speaker, includes a movable plate 124a directly abutting the dust cap 121 or directly abutting the balloon's surface without the dust cap 121. The movable plate 124a moves up and down to cause vibrations in response to the audio signal received from the music player 110 via the cable 130. This vibration by the movable plate 124a causes air pressure at the conjunct surface 120a to change and produces rich sounds via the gas in the balloon. The speaker 124 may also include a coil and a permanent magnet which produce the vibrations of the movable plate 124a. As shown, the internal components of the speaker 124 are at least partially enclosed by a protective shell 124b.

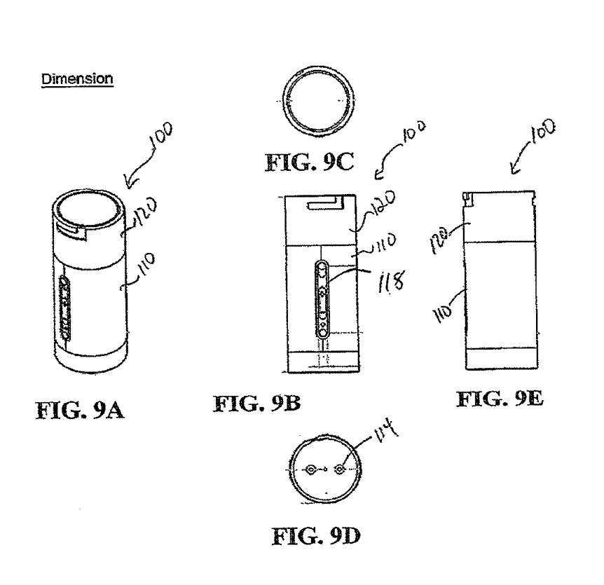

FIGS. 9A-9E show different views of the musical assembly 100 and illustrative dimensions of the musical assembly. FIG. 9A shows a front perspective view of the assembly, FIG. 9B shows a front view of the assembly, FIG. 9C shows a top view of the assembly, FIG. 9D shows a bottom view of the assembly and FIG. 9E shows a side view of the assembly. In the illustrative example of FIGS. 9A-9E, the weight of the musical assembly is about 80 grams, and the total height of the musical assembly, when it is collapsed and not in use, is about 100.5 mm. The height of the speaker module 120 is about 28 mm, the height of the control panel 118 on the music player 110 is about 37.9 mm and the width of the control panel is about 5 mm. As also shown, the diameter of the cylindrical musical assembly is about 40 mm.

As mentioned above, the music player 110 includes a battery for providing power for the operation of the musical assembly 100 and the battery can be recharged using a power port, such as a micro USB port. In the illustrative example of FIGS. 9A-9E, the battery voltage is 3.7 V and battery capacity is 600 mAh which allows for about 6 hours of audio playtime. The musical assembly 100 includes at least two inputs, a wireless (Bluetooth) input for receiving sound signals from an external device and a microphone input, which can be provided at the bottom of the music player 110. The wireless reception range is about 10 meters, although smaller or greater ranges may be used.

The musical assembly 100 of FIGS. 9A-9E can be used with an 80 L balloon filled with helium. However, balloons of other sizes and filled with other gases may be used with the musical assembly 100. Depending on the size of the balloon, the dimensions of the musical assembly may be adjusted.

As mentioned above, the musical assembly 100 may be used to connect multiple balloons so as to play music using two or more balloons simultaneously. In some embodiments, the musical assembly 100 may include one or more additional speaker modules attached by one or more cables to the music player 110. These additional speaker modules and cables may be detachable/releasable from the music player 110 so as to allow to attach and detach additional balloons from the music player 110.

In other embodiments, each music player 110 is used with one speaker module and thus, with one balloon but can be connected to other music players 110 either wirelessly or by a wire so as to create a network of music players 110 capable of playing the same sounds simultaneously. The network of music players 110 may have various configurations, such as a daisy chain configuration where the music players 110 are connected in series and convey the audio signal to the next music player, or a star configuration with one main music player connected to other music players and transmitting the audio sounds to these other music players. Other configurations may be used, such as a ring, a tree, a mesh, and the like. In other embodiments, the music players 110 may all be directly connected to the external device 300, either wirelessly or by a wire, so that each of the music players 110 receives audio signals directly from the externals device. Other arrangements of the multiple music players are possible and are not limited to the above-described configurations.

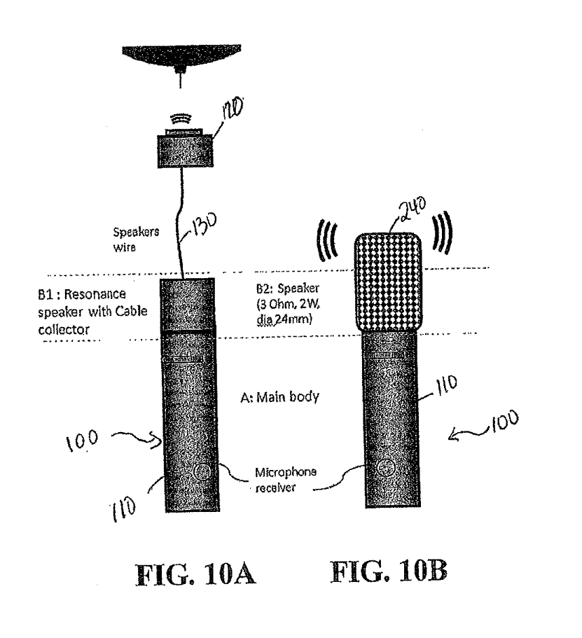

FIGS. 10A and 10B show another configuration of the musical assembly 100 of the present invention. Most of the components of the musical assembly 100 in FIGS. 10A and 10B are the same or similar to those described above and detailed description thereof will be omitted. In the musical assembly 100 of FIGS. 10A and 10B, the speaker module 120 may be detachable from the cable 130 and from the music player 110 so that the speaker module 120 can be exchanged for a regular larger sized speaker 420, as shown in FIG. 10B. In this embodiment, the speaker module 120 is detached from the cable, and the cable is instead connected to the regular speaker 420 which does not require a balloon or another device for amplification of sound. In an illustrative embodiment, the speaker 420 is a 3 Ohm, 2 W speaker with a diameter of 24 mm. However, other size and configuration speakers may be used with the musical assembly 100 of this embodiment.

The above described embodiments of the musical assembly is adapted to receive audio signals, such as music or the like, from an external device via a wireless connection, e.g., Bluetooth, and to also receive sounds via a microphone incorporated into the musical assembly, wherein the external device can include, but is not limited to, a portable music player, a radio tuner, a mobile or remote terminal (cellular or landline telephone), a CD/DVD player, a Radio Data System (RDS) tuner, an Internet radio, a cassette player, a satellite radio, a text-to-speech system, a television tuner, an MP3 player, a computer, an audio/visual system, a navigation system, or other devices capable of storing and/or producing music or other sounds. In such embodiments, the musical assembly preferably does not store any audio files that are played by the assembly and may not include any storage device for storing audio files to be played, and all of the audio signals are received from an external device either wirelessly or through a wired connection and/or via the microphone. However, it is contemplated that the musical assembly may include a built in memory or a storage device for storing audio files to be played by the musical assembly, in addition to being able to receive audio signals from the external device or via the microphone. Moreover, in some embodiments, the musical assembly may include a data storage input port, such as a media card input port, for inserting or connecting a data storage device, such as a storage card, an SD card or any other suitable storage device, with audio files stored thereon so that the musical assembly can read out and play the audio files stored on the data storage device.

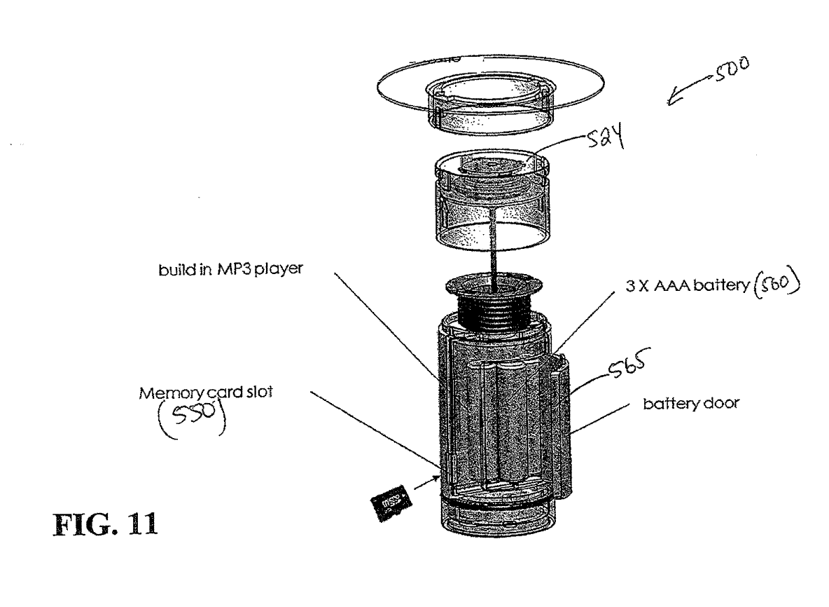

In addition to the above-described embodiments of the musical assembly, the present invention also contemplates other embodiments of the assembly. FIG. 11 shows another embodiment of the musical assembly 500 of the present invention. As shown in FIG. 11, the construction of the musical assembly 500 in this embodiment is similar to or substantially the same as the construction of the musical assembly 100 in the above-described embodiments. Therefore, description of the components of the musical assembly 500 that are similar to those described above will be omitted.

In the embodiment of FIG. 11, the musical assembly 500 does not include wireless communication capability and does not include a communication processor. Instead, the musical assembly 500 may include a memory or similar storage device for storing audio files to be played by the musical assembly. As shown in FIG. 11, the musical assembly also includes a storage device input port 550 for connecting a storage device with audio files thereon. The storage device input port 550 may be provided either instead of, or in addition to, the memory or internal storage device in the musical assembly. As shown, the storage device input port 550 may be in the form of a memory card slot that allows a memory card, such as an SD card, to be inserted so that audio files stored thereon can be read out and played by the musical assembly 500. Although not shown, in some embodiments, the musical assembly may allow an external storage device to be connected thereto so that the musical assembly can read out audio files stored on the external storage device and output audio sounds corresponding to the read out audio files.

The main processor of the musical assembly 500 controls reading out of the audio files from the internal storage device, from the storage device inserted into the input port 550 and/or the external storage device connected to the musical assembly, and outputting of the audio sounds using the speaker 524. In this way, the musical assembly 500 is able to function as an MP3 player or similar audio player device.

In the embodiment of FIG. 11, the musical assembly uses standard removable and replaceable batteries 560 instead of the built-in rechargeable battery. In the illustrative assembly 500 of FIG. 11, the musical assembly uses three standard AAA batteries which can be removed and replaced by opening a battery door 565 in the music player 510 of the musical assembly. However, the number and type of batteries used is not limited to three AAA batteries and may be varied depending on the construction of the musical assembly. In other embodiments, a built-in rechargeable battery may be used as in the other embodiments described above.

The embodiment shown in FIG. 11 is a low cost version of the musical assembly. It is understood that the exact configuration and features included in the musical assembly may be varied depending on the anticipated uses and cost of the assembly. In all cases it is understood that the above-described arrangements are merely illustrative of the many possible specific embodiments which represent applications of the present invention. Numerous and varied other arrangements can be readily devised in accordance with the principles of the present invention without departing from the spirit and scope of the invention.

In the specification the terms “comprise, comprises, comprised and comprising” or any variation thereof and the terms “include, includes, included and including” or any variation thereof are considered to be totally interchangeable and they should all be afforded the widest possible interpretation.

### Advantages of the Present Invention

It is an advantage of the present invention is to provide a musical assembly that can be used with one or more inflatable balloons, in which one or more speaker modules is each attached to the surface of one or more inflatable balloons such that the balloon amplifies the sounds from one or more speakers.

It is another advantage of the present invention to provide a musical assembly that can be used with one or more inflatable balloons, having one or more audio players which each can wirelessly receive sound signals from one or more external audio devices through a Bluetooth connection between one or more audio players and one or more external audio devices.

It is another advantage of the present invention to provide a musical assembly that can be used with one or more inflatable balloons, having one or more audio players which each can wirelessly receive sound signals from one or more external audio devices through a wired connection between one or more audio players and one or more external audio devices.

It is another advantage of the present invention to provide a musical assembly that can be used with one or more inflatable balloons, having one or more audio players which can each be wirelessly controlled via a Bluetooth connection between one or more audio players and one or more external control panel.

It is another advantage of the present invention to provide a musical assembly that can be used with one or more inflatable balloons, having one or more audio players which can be controlled by an integral control panel or a control panel connected to one or more of the audio players each via a wired connection.

It is another advantage of the present invention to provide a musical assembly that can be used with one or more inflatable balloons, having one or more audio players having one or more detachably attached speaker modules.

It is another advantage of the present invention to provide a musical assembly that can be used with one or more inflatable balloons, that can be used as a speaker phone, a loud speaker, or as a karaoke device.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A musical assembly used with one or more inflatable balloons, comprising:
a) one or more audio players for receiving and transmitting audio signals;
b) one or more extendable wire cables each having:
(i) a proximal end that is extendably and electronically connected to each of said audio players; and
(ii) a distal end that is electronically connected to one or more speaker modules;
c) wherein each of said speaker modules includes a housing having at least one speaker therein for playing sounds and having an adapter therein for releasably connecting each of said speaker modules to said one or more inflatable balloons; and
d) wherein each of said inflatable balloons including a gas expandable interior and an outer surface, wherein said sounds are amplified when they pass through said gas expandable interior and wherein said sounds are further amplified when said sounds cause said outer surface of each of said inflatable balloons to vibrate.

2. A musical assembly in accordance with claim 1, wherein each of said one or more audio players wirelessly receives sound signals from an external audio device, including a portable music player, a radio tuner, a cellular telephone, a landline telephone, a CD/DVD player, a Radio Data System (RDS) tuner, an Internet radio, a cassette player, a satellite radio, a text-to-speech system, a television tuner, an MP3 player, a computer, an audio/visual system, or a navigation system.

3. A musical assembly in accordance with claim 2, wherein each of said one or more audio players wirelessly receives sound signals from an external audio device through a Bluetooth connection between said audio player and said external audio device.

4. A musical assembly in accordance with claim 1, wherein each of said one or more audio players receives sound signals from an external audio device through a wired connection between said audio player and said external audio device.

5. A musical assembly in accordance with claim 1, wherein each of said one or more audio players wirelessly receives external sound signals through a microphone connected to said audio player.

6. A musical assembly in accordance with claim 1, wherein each of said one or more audio players receives a plurality of sound signals via wireless connection, via wired connection, or via a combination of wired and wireless connections.

7. A musical assembly in accordance with claim 1 comprising an internal or external memory storage assembly for storing and playing a plurality of audio files.

8. A musical assembly in accordance with claim 1, wherein each of said one or more audio players comprises a housing having a substantially cylindrical, spherical, or oblong shape.

9. A musical assembly in accordance with claim 1, wherein each of said one or more audio players has sufficient to serve as a weight for the balloon to prevent said inflatable balloon from flying away.

10. A musical assembly in accordance with claim 1, wherein each of said one or more audio players includes an integral or external control panel with one or more controls for controlling the operation of said audio player, said speaker module, and power management of said musical assembly, via a wireless connection or via a wired integral connection.

11. A musical assembly in accordance with claim 10, wherein each of said one or more audio players includes one or more other controls for: turning said audio player on and off, for causing said audio player to stop, pause, or play music, for causing said audio player to advance to play a next audio track, rewinding to play a previous played audio track or rewinding to play the first audio track, or for turning on and off said microphone.

12. A musical assembly in accordance with claim 1, having multiple musical assemblies that can be networked via a wireless or via a wired connection.

13. A musical assembly in accordance with claim 1, wherein each of said one or more speaker modules is detachable from said cable.

14. A musical assembly in accordance with claim 1, wherein each of said one or more speaker modules is integrally attachable to said audio player in a first position and retractably extendable via said cable from said audio player in a second position.

15. A musical assembly in accordance with claim 1, wherein each of said one or more audio players can be detachably connected to one or more resonance speakers, vibration speakers, or conventional audio loudspeakers, via said one or more cables.

16. A musical assembly in accordance with claim 1, wherein each of said one or more audio players comprises a winding mechanism for retractably extending said cable from said audio player.

17. A musical assembly in accordance with claim 1, wherein each of said one or more wire cables can be wound and stored around or inside of said audio player.

19. A musical assembly in accordance with claim 1, wherein each of said one or more inflatable balloons comprises an aluminum foil balloon, an airship, a bottle or a box.

20. A musical assembly in accordance with claim 1, wherein each of said one or more inflatable balloons can be filled with an expandable gas comprising compressed air, nitrogen, helium, or carbon dioxide.
